(19) United States
(12) Patent Application Publication
(10) Pub. No.: US 2021/0104735 A1
(43) Pub. Date: Apr. 8, 2021

(54) ANODE ACTIVE MATERIAL FOR LITHIUM ION BATTERY, ANODE FOR LITHIUM ION BATTERY AND LITHIUM ION BATTERY

(71) Applicant: Daxin Materials Corporation, Taichung City (TW)

(72) Inventors: Jui-Shen Chang, Taichung City (TW); Yun-Shan Lo, Taichung City (TW); Kuo-Cheng Huang, Taichung City (TW)

(21) Appl. No.: 16/810,859

(22) Filed: Mar. 6, 2020

(30) Foreign Application Priority Data
Oct. 8, 2019 (TW) 108136450

(51) Int. Cl. H01M 4/36; H01M 10/0525; H01M 4/38; H01M 4/587; H01M 4/62

(52) U.S. Cl. CPC H01M 4/364; H01M 10/0525; H01M 4/386; H01M 2004/027; H01M 4/587; H01M 4/622; H01M 4/387

(57) ABSTRACT

An anode active material of a lithium ion battery includes primary particles. The primary particles include Si, Sn and Sb. The primary particles have peaks at X-ray diffraction 2θ position of 29.1±1°, 41.6±1°, 51.6±1°, 60.4±1°, 68.5±1°, and 76.1±1°.

### CROSS-REFERENCE TO RELATED APPLICATION

This application claims priority to Taiwan Application Serial Number 108136450, filed Oct. 8, 2019, which is herein incorporated by reference.

### BACKGROUND

### Field of Invention

The present disclosure relates to an anode active material of a lithium ion battery, an anode of the lithium ion battery and the lithium ion battery.

### Description of Related Art

In recent years, one type of the emerging batteries is the lithium-ion battery, which is advantageous over high energy density, small self-discharge, long lifetime of cycles, less memory effect, and less environmental pollution.

Silicon is one of materials that show a higher specific capacitance among the various types of anode materials for lithium-ion batteries. Thus, silicon-based materials are used as anodes in batteries commonly. However, in the conventional lithium-ion battery equipped with the silicon-based anode, the volume thereof is prone to be considerably changed during charging and discharging periods, thereby leading to the fracture of the construction of the battery. Accordingly, the lifetime duration and safety of the batteries are undesirably deteriorated. Therefore, there is an urgent need for a solution capable of improving the problem of volume change mentioned above.

### SUMMARY

According to one aspect of the present disclosure, an anode active material for a lithium ion battery, including primary particles, including Si, Sn and Sb, wherein the primary particles have peaks at 2θ positions of 29.1±1°, 41.6±1°, 51.6±1°, 60.4±1°, 68.5±1° and 76.1±1° in X-ray diffraction.

In some embodiments, a molar percentage of Si of the primary particles is ranged from 5% to 80%, a molar percentage of Sn of the primary particles is ranged from 10% to 50% and a molar percentage of Sb of the primary particles is ranged from 10% to 50%.

In some embodiments, the primary particles further include carbon, based on a total weight of the anode active material of the lithium ion battery being 100 wt %, a weight percentage of carbon is less than 10 wt %.

In some embodiments, the primary particles include Si—Sn—Sb alloys.

In some embodiments, the primary particles further include Si in an elemental state, Sn in an elemental state, or Sb in an elemental state.

In some embodiments, a particle size of the primary particles of the anode active material of the lithium ion battery is ranged from 200 nm to 500 nm.

According to another one aspect of the present disclosure, an anode for the lithium ion battery includes the anode active material for the lithium ion battery.

In some embodiments, the anode for the lithium ion battery further includes a conducting material and an adhesive agent, in which the anode active material for the lithium ion battery is adhesive to the conducting material by the adhesive agent.

In some embodiments, the adhesive agent includes a polymer, copolymer or combination thereof having at least one structure of polyvinylidene difluoride (PVDF), styrene-butadiene rubber latex (SBR), carboxymethyl cellulose (CMC), polyacrylate (PAA), polyacrylonitrile (PAN), polyvinyl alcohol (PVA), and sodium alginate.

According to another one aspect of the present disclosure, a lithium ion battery includes the anode.

In some embodiments, the lithium ion battery further includes a cathode and an electrolyte disposed between the anode and the cathode.

### BRIEF DESCRIPTION OF THE DRAWINGS

In order to make the above and other objects, features, advantages, and embodiments of the present invention more comprehensible, the detailed description of the drawings is as follows.

FIG. 1 shows an X-ray diffraction pattern of the anode active material of the lithium ion battery according to the Example 1 of the present invention.

FIG. 2 is a scanning electron microscope photograph of the anode active material of the lithium ion battery according to Example 1 of the present invention.

FIG. 3 is a scanning electron microscope photograph of the anode active material of the lithium ion battery of Comparative Example 2.

### DETAILED DESCRIPTION

In order to make the description of the present invention more detailed and complete, reference may be made to the accompanying drawings and various implementations or examples described below.

As used herein, the singular number includes the plural referent unless there are other clear references in the present disclosure. By referring to a specific reference such as “an embodiment”, in at least one of the embodiments of the present invention, it represents a specific feature, structure, or characteristic. When the special reference appears, there is no need to refer to the same embodiment. Furthermore, in one or more embodiments, these special features, structures, or characteristics can be combined with each other as appropriate.

Generally, in the conventional lithium-ion battery equipped with the silicon-based anode, the volume thereof is prone to be considerably changed during charging and discharging periods, thereby leading to the fracture of the construction of the battery. Accordingly, the lifetime duration and safety of the batteries are undesirably deteriorated.

The present invention providing an anode active material for a lithium ion battery includes primary particles. The primary particles include Si, Sn and Sb. The primary particles have peaks at 2θ positions of 29.1±1°, 41.6±1°, 51.6±1°, 60.4±1°, 68.5±1°, and 76.1±1° in X-ray diffraction. It is noted that, Si, Sn and Sb of the anode active material for the lithium ion battery are dispersed uniformly in the primary particles in some embodiments.

In some embodiments, for the primary particles of the anode active material for the lithium ion battery, the mole percentage of Si is ranged from 5 to 80%, preferably is ranged from 10% to 70%, such as 10%, 20%, 30%, 40%, 50%, 60% or 70%. The mole percentage of Sn is ranged from 10% to 50%, such as 20%, 30%, or 40%, and preferably ranged from 12% to 45%. The mole percentage of Sb is ranged from 10% to 50%, such as 20%, 30% or 40%, preferably ranged from 12% to 45%. Si, Sn, and Sb can be chemically combined with lithium, so that a higher capacitance of the lithium ion battery can be reached. The mole percentages of Si, Sn, and Sb can be adjusted according to demands.

In some embodiments, the primary particles of the anode active material for the lithium ion battery further include carbon. Based on a total weight of the anode active material of the lithium ion battery being 100 wt %, the weight percentage of carbon is less than 10 wt %. For example, 9 wt %, 8 wt %, 7 wt %, 6 wt %, or 5 wt %. The aid of carbon is increasing the conductivity of the anode active material of the lithium ion battery and also increasing the capacitance of the anode active material of the lithium ion battery. If the weight percentage of carbon is too large, for example, greater than 10 wt %, it leads to the specific surface area of the anode active material of the lithium ion battery being too large after high-energy ball milling, and affects the electrical properties of the battery, such as the initial coulombic efficiency.

It is noted that the primary particles described above refer to the initial particles (smallest particles) obtained during the high-energy ball milling process. Multiple primary particles may aggregate together to form secondary particles, and the particle size of the secondary particles is larger than that of the primary particles.

In some embodiments, the primary particles of the anode active material for the lithium ion battery include Si—Sn—Sb alloys. In some other embodiments, the silicon in the primary particles is elemental Si, tin in the primary particles is elemental Sn, and antimony in the primary particles is elemental Sb. In other embodiments, the primary particles include Si—Sn—Sb alloys and elemental Si, elemental Sn, and elemental Sb. For Si—Sn—Sb alloys, bonding occurs between Si and Sn, and between Si and Sb, thus the volume expansion of Si during charge and discharge periods can be greatly reduced. The degree of expansion of the anode active material of the lithium ion battery can also be reduced.

In some embodiments, the particle size of the primary particles of the anode active material of the lithium ion battery is ranged from 200 nm to 500 nm, such as 250 nm, 300 nm, 400 nm, or 450 nm. In detail, in one embodiment, the D₁₀ of the primary particles of the anode active material of the lithium ion battery is 240 nm, D₅₀ is 400 nm, and D₉₀ is 650 nm.

The anode active material for the lithium ion battery of the present invention can be formed using method of high-energy ball milling. In detail, the powders having elemental Si, elemental Sn, and elemental Sb are mixed in a ball mill tank. In the method of high-energy ball milling, heats are generated frictionally by the powders and the grinding ball (such as zirconia balls), thus the temperature inside the ball mill tank can be reached 300° C. Thereafter, the powders having Si, Sn, and Sb were ground into smaller particles during the ball milling process and therefore primary particles were formed. Due to the nanolization of grain, the activation energy required for alloying is reduced. The heat generated by the friction and the impact of the grinding ball makes the powders more easily alloyed. In some embodiments, during ball milling, it leads Si, Sn, and Sb to form Si—Sn—Sb alloys because of the high temperature. In other embodiments, not all of Si, Sn, and Sb form Si—Sn—Sb alloys, but leaving some of Si, Sn, and Sb which are in an elemental state.

The performance of the ball milling process can be affected by, for examples, the speed of high-energy ball milling, the size and density of the milling ball, a ratio of the weight of the milling ball to the weight of the powder, and the milling time. In some embodiments, ball milling is performed at a speed ranged from 100 rpm to 1000 rpm, and the diameter ranged from 5 mm to 15 mm of zirconia balls are used as the grinding balls. The ratio ranged from 5 to 10 of the weight of grinding ball to the weight of powder is applied, and the ball milling time is ranged from 2 hours to 10 hours.

The anode active material for the lithium ion battery provided by the present invention may also include carbonaceous materials or ceramic materials that are used as a source of carbon, which increases the cycle lifetime of the lithium ion battery or the structural stability of the anode electrode material. The carbonaceous materials described above include shaped carbon or amorphous carbon, such as but not limited to, carbon black, activated carbon, graphite, graphene, carbon nanotubes, and carbon fibers. Such carbonaceous materials can be used in high-energy ball milling together with Si, Sn, and Sb to form a composite active material. After high-energy ball milling are performed on powders having Si, Sn, and Sb, the carbonaceous materials are then mixed together for gentle grinding and mixing, thereafter a carbon-coated structure is formed on the surface of the formed particles. The aforementioned ceramic materials are, for example, but not limited to, silicon dioxide, titanium dioxide, aluminum oxide, iron oxide, silicon carbide, and tungsten carbide.

The invention also provides an anode for a lithium ion battery, the anode includes aforementioned the anode active material for a lithium ion battery. In some embodiments, the anode for the lithium ion battery further includes a conductive material and an adhesive agent, and the anode active material for the lithium ion battery is adhesive to the conductive material by the adhesive agent.

In some embodiments, the conducting material is, for example, SUPER-P™, KS-6™, Ketjen Black, conductive graphite, carbon nanotubes, graphene, or vapor grown carbon fiber (VGCF). In some embodiments, based on a total weight of the anode of the lithium ion battery being 100%, the weight fraction of the conductive material is ranged from 5% to 20%, and preferably ranged from 15% to 20%, such as 16%, 17%, 18%, or 19%.

In some embodiments, the adhesive agent includes a polymer, copolymer or combination thereof having at least one structure of polyvinylidene difluoride (PVDF), styrene-butadiene rubber latex (SBR), carboxymethyl cellulose (CMC), and polyacrylate, (PAA), polyacrylonitrile (PAN), polyvinyl alcohol (PVA), and sodium alginate.

In addition, the present invention also provides a lithium ion battery including aforementioned the anode. In some embodiments, the lithium ion battery further includes a cathode and an electrolyte, in which the electrolyte is disposed between the anode and the cathode.

The electrical measurements of the present invention are performed by using a half-cell test. A method applying a lithium half battery for the electrical evaluation of the materials for a lithium battery is often used. The method applies a test sample as a working electrode, and both the counter electrode and reference electrode are lithium metal. Lithium metal is mainly used as a test platform to conduct electrical evaluation of test samples. In some embodiments, working electrode, the counter electrode and reference electrode are assembled into a button battery on which charging and discharging are performed.

Some comparative examples and examples of the present invention are exemplarily described below. It should be understood that the following examples are illustrative, and therefore are not intended to limit the embodiments of the present invention.

### Example 1

The powders having Si, Sn, and Sb were disposed in a ball mill tank, and grinding balls were disposed into the ball mill tank, in which the molar ratio of Si:Sn:Sb is 70:15:15. The ball milling at 400 rpm was applied in the ball milling process, and a diameter of 10 mm of zirconia balls were used as grinding balls. The ratio of the weight of grinding ball to the weight of the powder was 7.5, and the time period of the ball milling was 4 hours. The anode active material for the lithium ion battery was formed by ball milling.

Thereafter, the anode active material for the lithium ion battery was fabricated into an anode. The anode of the lithium ion battery included 76 wt % of the anode active material, 9 wt % of an adhesive agent (such as polyacrylate), and 15 wt % of a conductive material (such as carbon black). Firstly, the anode active material was mixed with the conducting material by using a planetary centrifugal mixer at 1500 rpm for 15 minutes. Thereafter, the solvent and the adhesive agent were added into the planetary defoamer, and they were continually mixed for 20 minutes at 2000 rpm in a planetary centrifugal mixer. The mixed slurry was coated on a copper foil, then dried and rolled to form the anode of the lithium ion battery.

The anode of the lithium ion battery was fabricated into a half-cell, and a charge-discharge cycle was performed at a current density of 500 mAh/g, in which the voltage was limited to a range of 0.005 V-1.5 V.

### Examples 2-7, and Comparative Examples 1, 3-4

The experimental procedure is the same as shown in Example 1. Reference can be made to Table 1 below for detailed ratios of each component.

### Comparative Example 2

The powders having SnO₂, Sb₂O₃, Si and carbon were mixed by using high-energy ball milling at a speed of 400 rpm for two hours, in which molar ratio of SnO₂:Sb₂O₃:Si:C was 2:1:3.5:10.5, that is, Sn:Sb:Si=2:2:3.5. Thereafter, the mixed powders were disposed into a furnace with high-temperature and under an argon atmosphere. The temperature was raised to 900° C. at a rate of 5° C./minute. The temperature was maintained at 900° C. for two hours, and then cooled to room temperature to obtain the anode active material for the lithium ion battery of Comparative Example 2.

Thereafter, the anode active material for the lithium ion battery was fabricated into an anode. As same as Example 1, the anode of the lithium ion battery of Comparative Example 2 included 76 wt % of the anode active material, 9 wt % of an adhesive agent (such as polyacrylate), and 15 wt % of a conductive material (such as carbon black). Firstly, the anode active material was mixed with the conducting material by using a planetary centrifugal mixer at 1500 rpm for 15 minutes. Thereafter, the solvent and the adhesive agent were added into the planetary centrifugal mixer, and they were continually mixed for 20 minutes at 2000 rpm in a planetary defoamer. The mixed slurry was coated on a copper foil, then dried and rolled to form the anode of the lithium ion battery.

The anode of the lithium ion battery was fabricated into a half-cell, and a charge-discharge cycle was performed at a current density of 500 mAh/g, in which the voltage was limited to a range of 0.005 V-1.5 V.

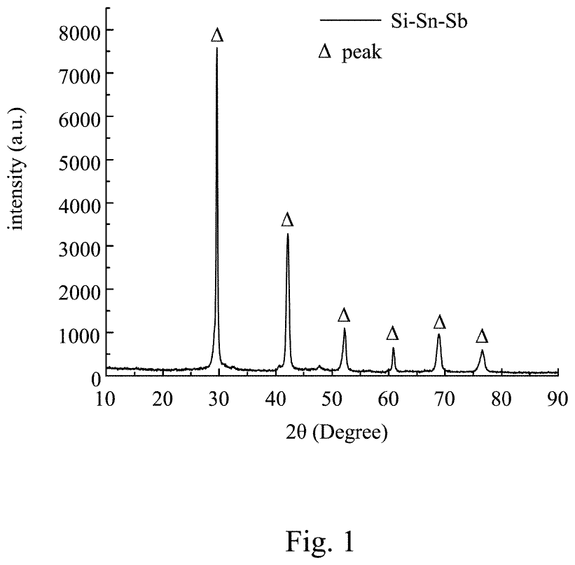

Referring to FIG. 1, which shows an X-ray diffraction pattern of the anode active material for the lithium ion battery according to the Example 1 of the present invention. As mentioned above, the primary particles of the anode active material for the lithium ion battery of the present invention have peaks at 2θ position of 29.1±1°, 41.6±1°, 51.6±1°, 60.4±1°, 68.5±1°, and 76.1±1° in X-ray diffraction. It can be confirmed from the X-ray diffraction pattern in FIG. 1 that the primary particles of the anode active material for the lithium ion battery of the present invention include Si—Sn—Sb alloys.

Table 1 shows the ratios of each component, experimental data, and the metal-product phase of comparative examples and the examples of the present invention.

TABLE 1

| | Molar percentage (at. %)/ Weight percentage (wt %) | | | | | | | | | | | | |
|---|---|---|---|---|---|---|---|---|---|---|---|---|---|
| | Si | | Sn | | Sb | | C | | Cu | | The initial coulombic | The capacity retention | Product |
| Element | at. % | wt % | at. % | wt % | at. % | wt % | at. % | wt % | at. % | wt % | efficiency (%) | rate after 10 cycles (%) | phase |
| Example 1 | 70 | 35 | 15 | 32 | 15 | 33 | — | — | — | — | 91 | 78 | Si-Sn-Sb |
| Example 2 | 60 | 26 | 20 | 37 | 20 | 37 | — | — | — | — | 89 | 84 | Si-Sn-Sb |
| Example 3 | 50 | 19 | 30 | 48 | 20 | 33 | — | — | — | — | 91 | 85 | Si-Sn-Sb, Sn |
| Example 4 | 46 | 17 | 27 | 41 | 27 | 42 | — | — | — | — | 90 | 84 | Si-Sn-Sb |
| Example 5 | 10 | 3 | 45 | 48 | 45 | 49 | — | — | — | — | 89 | 90 | Si-Sn-Sb |
| Example 6 | 50 | 32 | 15 | 40 | 5 | 14 | 25 | 7 | 5 | 7 | 88 | 82 | Si-Sn-Sb |
| | | | | | | | | | | | | | (Cu-based) |
| Example 7 | 56 | 34 | 12 | 30 | 12 | 31 | 20 | 5 | — | — | 90 | 85 | Si-Sn-Sb |
| Comparative | 85 | 57 | 12 | 34 | 3 | 9 | — | — | — | — | 90 | 49 | Si, Sn |
| Example 1 | | | | | | | | | | | | | |
| Comparative | 46 | 17 | 27 | 41 | 27 | 42 | — | — | — | — | 70 | 67 | Sn-Sb |
| Example 2 | | | | | | | | | | | | | alloys, |
| | | | | | | | | | | | | | Si |
| Comparative | 70 | 36 | 30 | 64 | — | — | — | — | — | — | 88 | 62 | Si, Sn |
| Example 3 | | | | | | | | | | | | | |
| Comparative | 70 | 35 | — | 65 | 30 | — | — | — | — | — | 89 | 15 | Si, Sb |
| Example 4 | | | | | | | | | | | | | |

As shown in Table 1, the initial coulombic efficiency of each of Examples 1-7 was greater than 88%, which was better than that of the Comparative Example 2. In addition, the capacity retention rates after 10 cycles of Examples 1-7 were significantly better than those of Comparative Examples 1-4. It should be understood that the measurement, such as initial coulombic efficiency and the capacity retention rate after 10 cycles in Table 1, they applied a formulation that can cause the battery to deteriorate faster, thus the performance of electrode materials were evaluated in just few cycles. In other words, the initial coulombic efficiency and the capacity retention rate after 10 cycles in Table 1 are only used for comparison between the examples and the comparative examples.

In addition, the content of Sb of Comparative Example 1 was too small, so that Si—Sn—Sb alloys was failed to be formed. It is noted that Comparative Example 2 produced the anode active material for the lithium ion battery by using a carbon reduction method, and the initial coulombic efficiency and the capacity retention rate after 10 cycles were much lower than those of Examples 1-7.

Table 1 showing that the examples of the present invention included Si—Sn—Sb alloys while Comparative Examples 1-4 did not include. As mentioned, Si—Sn—Sb alloys can suppress the volume expansion of silicon during the process of charge and discharge periods while Comparative Examples 1-4 (without Si—Sn—Sb alloys) have a larger degree of expansion of the electrode during charge and discharge periods. Due to the large volume change of Si during charge and discharge periods, the solid electrolyte interphase (SEI) formed on the anode electrode surface was therefore damaged, which resulting in the solid electrolyte interface film was repeatedly generated during the multiple cycles of charge and discharge. Too much solid electrolyte interface film was generated and much lithium ions were therefore consumed, such that the capacity and the lifetime duration of the lithium ion battery were reduced.

It is noted that Example 3 contains more Sn, so Example 3 also contains elemental Sn in addition to Si—Sn—Sb alloys. In other words, the anode active material for the lithium ion battery of the present invention may include not only Si—Sn—Sb alloys, but also Si in an elemental state, Sn in an elemental state, or Sb in an elemental state.

As shown in Table 1, it can greatly increase the capacity retention rate after 10 cycles by Si—Sn—Sb alloys and it can also maintain the initial coulombic efficiency above 88%.

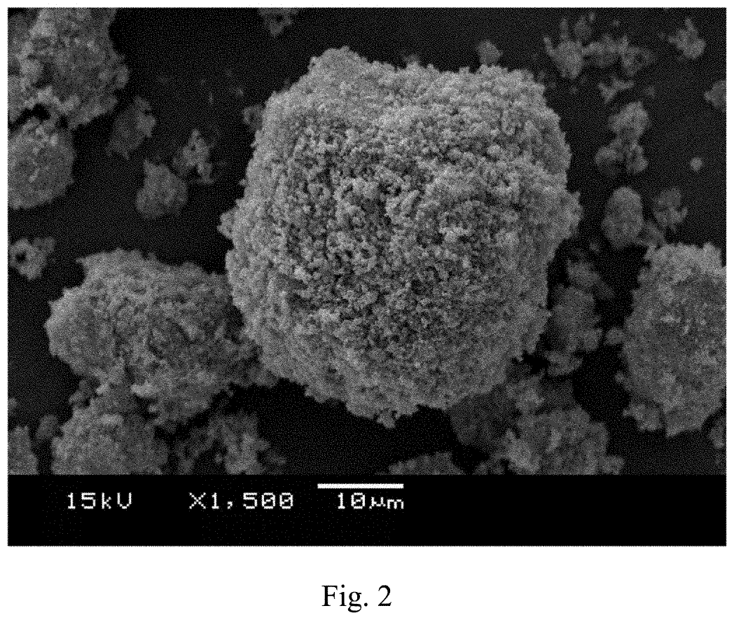

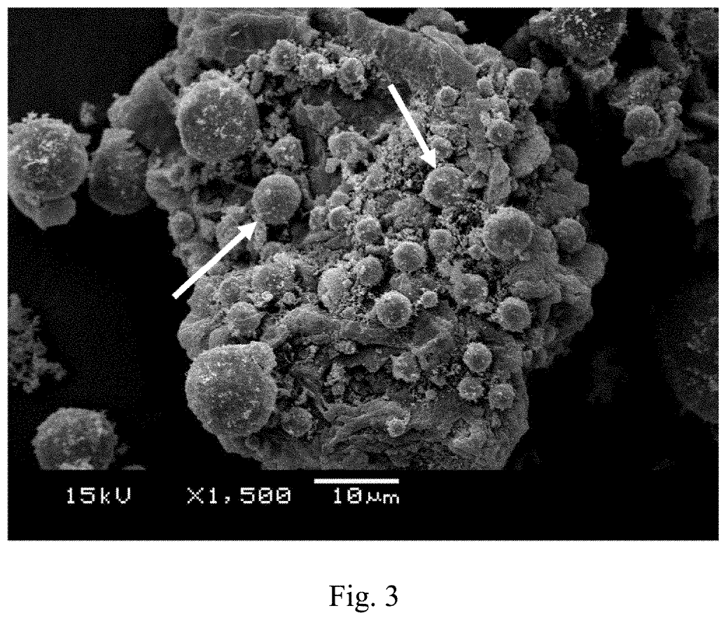

FIG. 2 is a scanning electron microscope photograph of the anode active material of the lithium ion battery according to Example 1 of the present invention. FIG. 3 is a scanning electron microscope photograph of the anode active material of the lithium ion battery of Comparative Example 2. As shown in FIG. 2, the surface of the primary particles of the embodiment produced by using the high-energy ball milling method was flat, which indicated that each element was uniformly distributed. There were many precipitated spheres (for example, at arrows), and phase separation occurred on the surface of the primary particles shown in FIG. 3. The inventors confirmed that the precipitated spheres are Sn—Sb alloys by using elemental analysis. It showed that Comparative Example 2 produced by the reduction method precipitated Sn—Sb alloys on the surface of the particles. In detail, the mixture was heated to 900° C. in the reduction method. The Sn—Sb alloys were precipitated out of the particles' surface because of the high-temperature environment, and the Sn—Sb alloys failed to be uniformly mixed with other elements (such as Si) to form the primary particles of Si—Sn—Sb alloys. Therefore, when applying the reduction method, it fails to produce Si—Sn—Sb alloys but cause the precipitation of Sn—Sb alloys, which is disadvantageous for a uniform dispersion of elements in the mixture. In other words, primary particles containing Si—Sn—Sb alloys fail to be formed by using the reduction method.

The present invention provides an anode active material for the lithium ion battery, which can greatly suppress the volume expansion of the Si-based electrode and increase lifetime duration of the battery. In addition, the anode for the lithium ion battery and the lithium ion battery provided by the present invention also exhibit excellent electrical properties.

The disclosure of the present invention has described certain embodiments in detail, but other embodiments are also possible. Therefore, the spirit and scope of the appended claims should not be limited to the embodiments described herein.

Although the present invention has been disclosed in the above embodiments, it is not intended to limit the present invention. Any person skilled in the art can make various modifications and retouches without departing from the spirit and scope of the present invention. Therefore, the scope of protection of the present invention shall be determined by the scope of the attached patent application.

What is claimed is:

1. An anode active material for a lithium ion battery, comprising:
primary particles, including Si, Sn and Sb, wherein the primary particles have peaks at 2θ positions of 29.1±1°, 41.6±1°, 51.6±1°, 60.4±1°, 68.5±1° and 76.1±1° in X-ray diffraction.

2. The anode active material for the lithium ion battery of claim 1, wherein a molar percentage of Si of the primary particles is ranged from 5% to 80%, a molar percentage of Sn of the primary particles is ranged from 10% to 50% and a molar percentage of Sb of the primary particles is ranged from 10% to 50%.

3. The anode active material for the lithium ion battery of claim 1, wherein the primary particles further comprise carbon, based on a total weight of the anode active material of the lithium ion battery being 100 wt %, a weight percentage of carbon is less than 10 wt %.

4. The anode active material for the lithium ion battery of claim 1, wherein the primary particles comprise Si—Sn—Sb alloys.

5. The anode active material for the lithium ion battery of claim 4, wherein the primary particles further comprise Si in an elemental state, Sn in an elemental state, or Sb in an elemental state.

6. The anode active material for the lithium ion battery of claim 1, wherein a particle size of the primary particles of the anode active material of the lithium ion battery is ranged from 200 nm to 500 nm.

7. An anode for a lithium ion battery, comprising:
the anode active material for the lithium ion battery according to claim 1.

8. The anode for the lithium ion battery of claim 7, further comprising:
a conducting material; and
an adhesive agent, wherein the anode active material for the lithium ion battery is adhesive to the conducting material by the adhesive agent.

9. The anode for the lithium ion battery of claim 8, wherein the adhesive agent comprises a polymer, copolymer or combination thereof having at least one structure of polyvinylidene difluoride (PVDF), styrene-butadiene rubber latex (SBR), carboxymethyl cellulose (CMC), polyacrylate (PAA), polyacrylonitrile (PAN), polyvinyl alcohol (PVA), and sodium alginate.

10. A lithium ion battery, comprising:
the anode according to claim 7.

11. The lithium ion battery of claim 10, further comprising:
a cathode; and
an electrolyte disposed between the anode and the cathode.
